(19) United States
(12) Patent Application Publication
(10) Pub. No.: US 2020/0295929 A1
(43) Pub. Date: Sep. 17, 2020

(54) AUTHENTICATION DEVICE BASED ON BIOMETRIC INFORMATION AND OPERATION METHOD THEREOF

(71) Applicant: KT Corporation, Seongnam-si (KR)

(72) Inventors: Tae-Gyun KIM, Seongnam-si (KR); Daesung CHO, Seoul (KR); Myung Woo KIM, Guri-si (KR); In-Soo LEE, Yongin-si (KR)

(73) Assignee: KT Corporation, Seongnam-si (KR)

(21) Appl. No.: 16/062,745

(22) PCT Filed: Dec. 14, 2016
(86) PCT No.: PCT/KR2016/014627

§ 371 Date: Jun. 15, 2018

(30) Foreign Application Priority Data
Dec. 18, 2015 (KR) 10-2015-0182264

(51) Int. Cl. H04L 9/08; H04L 9/32; H04L 9/14

(52) U.S. Cl. CPC H04L 9/0869; H04L 9/14; H04L 9/0825; H04L 9/3231

(57) ABSTRACT

A biometric information based authentication device includes a seed data generator which generates seed data comprising biometric information and having a first length, an encryptor which encrypts the seed data to generate a first encryption value and a second encryption value having a second length, wherein the first encryption value and the second encryption value are different from each other, and an authentication information generator which generates at least one of a public key and a private key based on each of the first encryption value and the second encryption value which are input. The private key is discarded after use.

### TECHNICAL FIELD

Methods and apparatuses consistent with exemplary embodiments broadly relate to biometric information based authentication.

### BACKGROUND ART

A user who uses Internet banking stores and uses a certificate in a computer or a portable terminal in a company or a home. Alternatively, the user may be issued the certificate in a security token that can be carried. Here, the security token as a hardware security module (HSM) is generally referred to as a USB-type HSM. Generally, the HSM means a device that generates and stores an encryption key in hardware and may be implemented in a chip type, a PCMCIA token type, a PCI card, or a network server type in addition to a USB token type.

The certificate is constituted by a pair of encryption keys generated based on a Public Key Infrastructure (PKI) and the encryption key may be called a public key and a private key. Thus, certificate issuance means generating and storing the encryption key. When the security token is issued, the public key and the private key are generated. The public key is transmitted to a certificate authority (CA) and the private key is stored in the security token. In this case, an RSA algorithm can be used as an algorithm for generating the public key and the private key.

As described above, a general HSM stores the encryption key in the hardware, and performs encryption, decryption, or electronic sign using the stored encryption key. In particular, since the encryption key cannot be exported outside of or from the HSM, the HSM has a higher level of security than a method for storing a key on a hard disk or a memory. However, the general HSM continuously stores the generated encryption key therein. Thus, in the general HSM, a possibility that the stored encryption key will be exposed is not completely eliminated even though the general HSM has the higher level of security than the method for storing the key in the hard disk or memory of the computer. Therefore, there is a need for a method for increasing the security level compared with the method for storing the encryption key inside a hard disk or the HSM.

Meanwhile, there is a technique of authenticating the user based on the identity of biometric information, granting an authority to access the stored encryption key to an authorized user or encrypting and storing the encryption key with biometric information. However, since the encryption key needs to be stored, there is still a possibility that the encryption key will be exposed.

### DISCLOSURE

### Technical Problem

The present disclosure has been made in an effort to provide an authentication device and an authentication method that generate a private key based on biometric information whenever an authentication event occurs and perform authentication based on the generated private key.

### Technical Solution

An exemplary embodiment provides a biometric information based authentication device. The biometric information based authentication device includes a seed data generator which generates seed data comprising biometric information and having a first length, an encryptor which encrypts the seed data to generate a first encryption value and a second encryption value having a second length, wherein the first encryption value and the second encryption value are different from each other, and an authentication information generator which generates at least one of a public key and a private key based on each of the first encryption value and the second encryption value which are input. The private key is discarded after use.

The authentication information generator may generate a first prime value and a second prime value by converting each of the first encrypted value and the second encrypted value to prime numbers, respectively, and generate the public key and the private key based on a key generation algorithm in which the first prime value and the second prime value are inputs.

The authentication information generator may calculate a first prime conversion value and a second prime conversion value to convert the first encryption value and the second encryption value into the first prime value and the second prime value, respectively, and may store the first prime conversion value and the second prime conversion value in a storage.

The authentication information generator, in response to receiving the first encryption value and the second encryption value at a time of authenticating an event, may retrieve, from the storage, the first prime conversion value and the second prime conversion value, calculate the first prime value based on the first encryption value and the first prime conversion value, and calculate the second prime value based on the second encryption value and the second prime conversion value.

The authentication information generator may generate the public key and the private key using an RSA key generation algorithm.

The seed data generator may generate the seed data comprising the biometric information and additional identification information. The additional identification information may include at least one of identification information of the authentication device, identification information of a hardware component of the authentication device, and identification information related to a user.

Another exemplary embodiment provides a method of registering authentication information by a biometric information based authentication device. The method includes generating seed data comprising biometric information and having a first length, encrypting the seed data to generate a first encryption value and a second encryption value having a second length, wherein the first encryption value and the second encryption value are different from each other, generating a first prime value and a second prime value by converting the first encryption value and the second encryption value into prime numbers, respectively, generating a public key and a private key based on a key generation algorithm in which the first prime value and the second prime value are inputs, and requesting registration of the authentication information by transmitting the public key to a certificate authority. The private key is discarded after use.

The generating the first prime value and the second prime value may include calculating a first prime conversion value and a second prime conversion value to convert the first encryption value and the second encryption value into the first prime value and the second prime value, respectively, calculating the first prime value based on the first encryption value and the first prime conversion value, calculating the second prime value based on the second encryption value and the second prime conversion value, and storing the first prime conversion value and the second prime conversion value.

The generating of the seed data may include generating the seed data comprising the biometric information and additional identification information. The additional identification information may include at least one of identification information of the authentication device, identification information of a hardware component of the authentication device, and identification information related to a user.

The biometric information may be fingerprint information. The generating the seed data may include generating the seed data by combining the fingerprint information and identification information of a sensor which detects the fingerprint information.

Yet another exemplary embodiment provides an authentication method of a biometric information based authentication device. The method includes receiving an authentication request for a specific event, receiving biometric information, generating a private key based on the biometric information, and encrypting data related to the specific event based on the private key, and transmitting the encrypted data to a certificate authority. The private key is discarded after the encrypting.

The generating the private key may include generating seed data comprising the biometric information and having a first length, encrypting the seed data to generate a first encryption value and a second encryption value having a second length, wherein the first encryption value and the second encryption value are different from each other, generating a first prime value and a second prime value by converting the first encryption value and the second encryption value into prime numbers, respectively, and generating the private key based on a key generation algorithm in which the first prime value and the second prime value are inputs.

The generating of the first prime value and the second prime value may include retrieving, from storage, a first prime conversion value and a second prime conversion value corresponding to the first encryption value and the second encryption value, respectively, and calculating the first prime value based on the first encryption value and the first prime conversion value retrieved, and calculating the second prime value based on the second encryption value and the second prime conversion value retrieved. The first prime conversion value may be used for converting the first encryption value into the first prime value of a prime number and the second prime conversion value may be used for converting the second encryption value into the second prime value of the prime number. The first prime value and the second prime value may be prime numbers.

The generating the seed data may include generating the seed data comprising the biometric information and additional identification information. The additional identification information may include at least one of identification information of the authentication device, identification information of a hardware component of the authentication device, and identification information related to a user.

The specific event may include at least one of a financial transaction related event, a payment related event, a website login related event, and a user authentication related event.

Yet another exemplary embodiment provides a biometric information based authentication device. The authentication device includes at least one sensor which detects biometric information, at least one communication interface which communicates with an external device, a memory which stores a program, a security module which encrypts input data and outputs encrypted input data, and a processor which interworks with the sensor, the communication interface, the memory, and the security module to execute operations of the program. The program includes instructions for generating a public key and a private key based on the biometric information received from the sensor, requesting registration of authentication information, and transmitting the generated public key with the requesting, to a certificate authority. The program further includes instructions for generating, in response to receiving an authentication request for a specific event, the private key based on the biometric information received from the sensor, encrypting data related to the specific event based on the generated private key, and transmitting the encrypted data to the certificate authority. The generated private key is discarded after use.

The program may include a first program executed at a time of requesting the registration of the authentication information. The first program may include instructions for generating seed data having a first length based on the biometric information received from the sensor, transmitting the seed data to the security module and receiving from the security module a first encryption value and a second encryption value having a second length, wherein the first encryption value and the second encryption value are different from each other, generating a first prime value and a second prime value by converting the first encryption value and the second encryption value into prime numbers, respectively, generating the public key and the private key based on a key generation algorithm in which the first prime value and the second prime value are inputs, and requesting the registration of the authentication information by transmitting the public key to the certificate authority.

The instructions for the generating the first prime value and the second prime value may include calculating a first prime conversion value and a second prime conversion value to convert the first encryption value and the second encryption value into prime numbers, respectively, calculating the first prime value based on the first encryption value and the first prime conversion value, calculating the second prime value based on the second encryption value and the second prime conversion value, and storing the first prim conversion value and the second prime conversion value.

The program may include a second program executed at a time of the requesting of the authentication of the specific event. The second program may include instructions for generating seed data having a first length based on the biometric information received from the sensor, transmitting the seed data to the security module and receiving from the security module a first encryption value and a second encryption value having a second length, wherein the first encryption value and the second encryption value are different from each other, generating a first prime value and a second prime value by converting the first encryption value and the second encryption value into prime numbers, respectively, generating the private key based on a key generation algorithm in which the first prime value and the second prime value are inputs, encrypting data related to the specific event based on the private key, and transmitting the encrypted data to the certificate authority.

The instructions for the generating the first prime value and the second prime value may include instructions for retrieving, from storage, a first prime conversion value and a second prime conversion value corresponding to the first encryption value and the second encryption key, calculating, in response to the retrieving the first prime conversion value and the second prime conversion value, the first prime value based on the first encryption value and the first prime conversion value, and calculating the second prime value based on the second encryption value and the second prime conversion value.

### Advantageous Effects

According to exemplary embodiments, since a private key is not stored, there is no possibility that the public key will be leaked to the outside from the authentication device, thereby increasing a security level as compared with other authentication device that stores the private key in hardware.

### DESCRIPTION OF THE DRAWINGS

FIG. 1 is a block diagram illustrating an authentication device, according to an exemplary embodiment.

FIG. 2 is a block diagram illustrating a system in which the authentication device is connected with other devices, according to an exemplary embodiment.

FIG. 3 is a block diagram illustrating hardware configuration of an authentication device, according to an exemplary embodiment.

FIG. 4 is a view illustrating a method of generating a P encryption value in an authentication device, according to an exemplary embodiment.

FIG. 5 is a flowchart illustrating a method of registering authentication information by an authentication device, according to an exemplary embodiment.

FIG. 6 is a flowchart illustrating an authentication method of generating authentication information based on an authentication event, by an authentication device, according to an exemplary embodiment.

FIG. 7 is a flow diagram illustrating a method of registering authentication information, according to another exemplary embodiment.

FIG. 8 is a flow diagram illustrating an authentication method, according to another exemplary embodiment.

### MODE FOR INVENTION

In the following detailed description, only certain exemplary embodiments have been shown and described, simply by way of an illustration. As those skilled in the art would realize, the described exemplary embodiments may be modified in various different ways, all without departing from the spirit or scope of the present disclosure. Accordingly, the drawings and description are to be regarded as illustrative in nature and not restrictive. Same reference numerals designate like elements throughout the present disclosure.

In addition, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

Biometric information used for authentication may be various different types, such as a fingerprint, an iris, a vein, and so on. Hereinafter, for description, a fingerprint is used as an example, but the biometric information used in the present disclosure is not limited to the fingerprint. Further, according to an exemplary embodiment, a plurality of biometric information can be combined and used for the authentication.

Throughout the specification, “delete/discard” or “not store” of a private key or a public key comprehensively refers to an operation for not storing the private key or the public key. The private key or public key may be not stored or may be not generated and stored as volatile information. Therefore, hereinafter, for description, an authentication device may be represented as deleting the private key or the public key, but this is to indicate that the private key or the public key is not stored in the authentication device and it is not particularly limited to not storing the private key or public key through an explicit delete command.

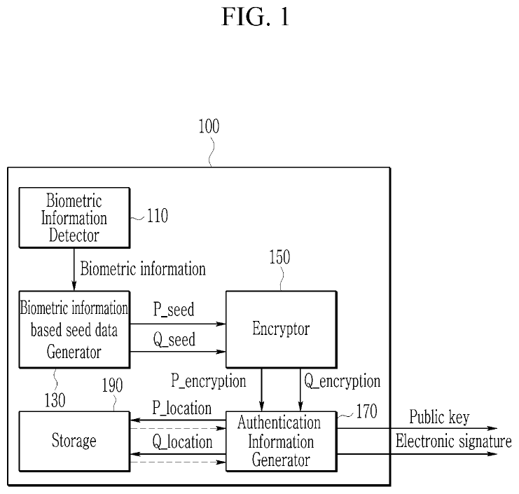

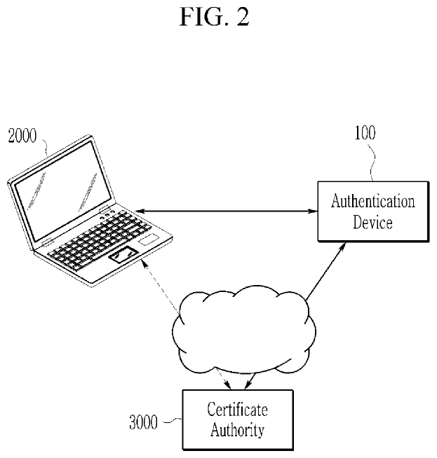

FIG. 1 is a block diagram illustrating an authentication device, according to an exemplary embodiment and FIG. 2 is a block diagram illustrating a system in which an authentication device is connected with other devices, according to an exemplary embodiment.

Referring to FIGS. 1 and 2, the authentication device 100 is a hardware security device including a processor (CPU) and an operating system (OS). When the authentication device 100 is connected to a computing device 2000, the authentication device is booted with supplied electricity and operates as an independent system from the computing device 2000. Further, when the authentication device 100 is connected to the computing device 2000, the authentication device 100 may disable some functions of the computing device 2000 and enable only internal functions of the authentication device 100.

Referring to FIG. 2, the authentication device 100 may be connected with the computing device 2000 through a communication interface (not illustrated). The communication interface may be selected from various wired/wireless interfaces. For example, the communication interface may be a USB interface, may be another communication interface which may be connected to the computing device. Further, the authentication device 100 may include a plurality of communication interfaces.

Further, the authentication device 100 may further include a communication interface (not illustrated) which may be directly connected to a communication network, that is, a communication module and may access a certificate authority 3000 through the communication module. The communication module may be selected from various communication modules that may be connected to a wired/wireless network. For example, the communication module may be a wireless communication module capable of wirelessly accessing an access point such as Bluetooth or WiFi or a wired communication module capable of accessing the communication network with a wired cable. Meanwhile, the authentication device 100 may include the communication module such that when the authentication device 100 is connected to the computing device 2000, the communication module for the Internet connection or the like of the computing device 2000 is disabled and the authentication device 100 may be implemented to access an external communication network only by the communication module of the authentication device 100.

The authentication device 100 includes a biometric information detector 110, a biometric information based seed data generator 130, an encryptor 150, an authentication information generator 170, and a storage 190.

The biometric information detector 110 is a sensor which detects, recognizes, or senses the biometric information of a user. The biometric information detector 110 is automatically activated when the authentication device 100 is supplied with electricity to be booted or the biometric information detector 110 may be activated by receiving a control signal from a controller (processor) of the authentication device 100. The biometric information detector 110 has unique sensor identification information (sensor id). Serial information of the sensor may be used as the sensor identification information, but is not limited thereto. Hereinafter, a fingerprint will be described as an example of the biometric information.

The biometric information based seed data generator (hereinafter, referred to as “seed data generator”) 130 generates data having a predetermined length based on fingerprint information detected by the biometric information detector 110. The seed data generator 130 transfers to the encryptor 150 data having a predetermined length, which includes fingerprint information. Since the data having the predetermined length, which includes the fingerprint information is used for generating keys of the encryptor 150 and the authentication information generator 170, the data is called seed data. In particular, the authentication information generator 170 generates a public key and a private key using specific values called a P value and a Q value and the seed data is used to generate the P value and the Q value. Therefore, hereinafter, the seed data will be referred to as P seed (P_seed) and Q seed (Q_seed). The P seed and the Q seed are different values. It is described that the seed data generator 130 generates each of the P seed and Q seed and transfers the generated seed data to the encryptor 150, but the seed data generator 130 may generate one seed data including the fingerprint information and the encryptor 150 may generate the P seed and the Q seed which are not the same as each other, by using the seed data.

At least one of the P seed and the Q seed includes the fingerprint information. The fingerprint information is a digital value indicating characteristics of the fingerprint and includes information (core_finger_print) of a predetermined area (core area) such as including the center of the fingerprint.

At least one of the P seed and the Q seed includes additional identification information. The additional identification information may be diversified and may be device related identification information such as identification information (e.g., serial number, etc.) of the authentication device 100 or identification information of specific hardware component of the authentication device 100. The identification information of the specific hardware component may be, for example, the sensor identification information (sensor id) of the biometric information detector 110. The additional identification information may be user-related identification information such as a user password, a user resident registration number (Social Security number), and the like. Alternatively, the additional identification information may be a combination of the device-related identification information and the user-related identification information. Hereinafter, for description, the additional identification information will be described with the sensor identification information (sensor_id) as an example, but is not limited thereto.

At least one of the P seed and the Q seed includes the additional identification information in addition to the fingerprint information. Hereinafter, for description, it is assumed that the P seed is data (P_seed=core_finger_print+sensor_id) in which the sensor identification information (sensor_id) is combined to the end of the fingerprint information (core_finger_print) and the Q seed is data (Q_seed=sensor_id+core_finger_print) in which the fingerprint information is combined to the end of the sensor identification information.

The data length of each of the P seed and the Q seed may vary according to a design of the encryptor 150 and 32 bytes will be described as an example.

The encryptor 150 receives the P seed and the Q seed from the seed data generator 130. The encryptor 150 outputs encrypted data having a predetermined length (for example, 128 bytes or 256 bytes) using the P seed and the Q seed. The encryptor 150 generates encrypted data such as 128 bytes/256 bytes from the P seed and the Q seed using an encryption algorithm. The encryption algorithm may be, for example, an Advanced Encryption Standard (AES) algorithm. The data output from the encryptor 150 are called a P encryption value (P_encryption) and a Q encryption value (Q_encryption). The encryptor 150 may be implemented as a hardware module.

The authentication information generator 170 receives input data required for key generation from the encryptor 150. The input data may vary depending on a key generation algorithm, but the input data particularly includes the biometric information. An RSA key generation algorithm is described as an example of the key generation algorithm, but the key generation algorithm is not limited thereto. Further, for description, the P value and the Q value which are terms used in the RSA key generation algorithm are used, but the P and Q values mean specific values used for key generation in the key generation algorithm and may be replaced with other terms.

The authentication information generator 170 receives the P encryption value and the Q encryption value from the encryptor 150. Then the authentication information generator 170 generates specific values (P value and Q value) required for generating the public key and the private key based on the P encryption value and the Q encryption value. In this case, the P value (P_prime) and the Q value (P_prime) are different prime numbers. That is, the RSA key generation algorithm is an algorithm for generating keys using different prime numbers and the values input from the encryptor 150 may not necessarily be different prime numbers. Therefore, the authentication information generator 170 may not operate the key generation algorithm by using the exact values input from the encryptor 150. Therefore, the authentication information generator 170 may generate the P value and the Q value of the prime numbers used for the key generation of the key generation algorithm from the P encryption value and the Q encryption value.

The authentication information generator 170 generates the public key and the private key by using the P value and the Q value according to the key generation algorithm. In the case of an authentication information registering operation, the authentication information generator 170 transmits the public key to the certificate authority 3000 and does not store the public key and the private key. In the case of an authentication operation, after the registration of the authentication information, the authentication information generator 170 completes an authentication procedure (e.g., encryption, decryption, electronic signature, and other user authentication) in the authentication event based on the generated private key and thereafter, does not store the private key. That is, the authentication information generator 170 generates the private key every time the authentication event occurs and discards the private key when the authentication event is completed.

Next, a method of generating the public key and the private key is described with the RSA key generation algorithm, as an example, but the key generation algorithm is not limited to the RSA key generation algorithm. The authentication information generator 170 generates a public key (N,e) and a private key (N,d) based on a P value (P_prime) which is a prime number and a Q value (Q_prime) which is also a prime number. Here, N represents the product (P_prime*Q_prime) of the P value and the Q value, e represents an integer number which is smaller than ϕ(N)(p−1)(q−1) and is a relative prime to ϕ(N), and d represents an integer [d*e=1 mod ϕ(N)] number having a remainder of 1 when the product of d and e is divided by ϕ(n), according to an exemplary embodiment.

The security tokens and security devices in related art may also use the RSA key generation algorithm. The devices in related art randomly receive a random number (N) from a certificate authority or the like, and generate the public key and the private key based on the P value and the Q value extracted from and obtained by breaking N. In this case, since the devices in related art generate the key based on the random number (N), when the key is generated every authentication, the key is changed every authentication, and as a result, the authentication information registering operation needs to be performed every authentication. Therefore, the devices in related art stores the private key generated in the authentication information registering operation. In addition, the devices in related art cannot but perform the authentication procedure by bringing the private key stored whenever the authentication event occurs.

On the contrary, according to an exemplary embodiment, instead of generating the key based on the random number, the authentication information generator 170 generates the key based on a fixed P value (P_prime) and a fixed Q value (Q_prime). Therefore, even when the key generation algorithm is repeatedly operated, the authentication information generator 170 may generate a key that is continuously the same as the previously generated key. The method for generating, by the authentication information generator 170, the P value (P_prime) and the Q value (Q_prime) from the P encryption value and the Q encryption value will be described below in greater detail, according to an exemplary embodiment.

The key generation algorithm of the authentication information generator 170 may generate the public key and the private key by using the P value and the Q value which are different prime numbers. However, the P encryption value and the Q encryption value received from the encryptor 150 may not be the prime number since the P encryption value and the Q encryption value are the result of encrypting the seed data. Accordingly, after determining whether the P encryption value and the Q encryption value are the prime numbers, the authentication information generator 170 converts the P encryption value and the Q encryption value into the prime numbers and generates the P value (P_prime) and the Q value (Q_prime) which are the prime numbers according to a predetermined rule when the P encryption value and the Q encryption value are not the prime numbers. A prime number change rule may be diversified and for example, the authentication information generator 170 adds or subtracts a specific value to or from each of the P encryption value and the Q encryption value to find prime numbers closest to the P encryption value and the Q encryption value, respectively. In addition, the authentication information generator 170 stores in the storage 190 specific values (prime number conversion values) added or subtracted for converting the P encryption value and the Q encryption value into the prime numbers. The specific values added or subtracted for converting the P encryption value and the Q encryption value into the prime numbers are called a P prime conversion value (P_Location) and a Q prime conversion value (Q_Location).

The storage 190 stores the P prime conversion value and the Q prime conversion value, received from the authentication information generator 170. The storage 190 may store the P prime conversion value and the Q prime conversion value during a predetermined period and delete the stored values when the corresponding period of time has elapsed. The period during which the P prime conversion value and the Q prime conversion value, are stored, may be fixed or deleted or updated by an operation (authentication information deletion request, authentication information update request, etc.) of the user.

The authentication information generator 170 does not store the private key. Therefore, whenever financial transaction such as Internet banking transaction, a financial settlement for purchase of merchandise transaction, a website login, and various authentication events requiring user authentications occur, the authentication information generator 170 needs to generate the private key. In this case, the authentication information generator 170 receives the P encryption value and the Q encryption value from the encryptor 150 and quickly generates a P value (P_prime=P_encryption+P_Location) and a Q value (Q_prime=Q_encryption+Q_Location) based on the P encryption value and the Q encryption value stored in the storage 190. That is, whenever the authentication information generator 170 generates the private key, the authentication information generator 170 can skip a determining procedure whether the value input from the encryptor 150 is the prime number, and the prime conversion procedure when the value is not the prime number. Therefore a private key generation time may be shortened.

As described above, according to an exemplary embodiment, the authentication device 100 may generate the P value and the Q value for key generation from the P seed and Q seed including the biometric information every time the authentication is performed. Therefore, the authentication device 100 need not store the private key therein, thereby enhancing security. Further, the authentication device 100 quickly generates the private key by using the P prime conversion value and the Q prime conversion value, thereby preventing an authentication procedure delay due to the key generation time.

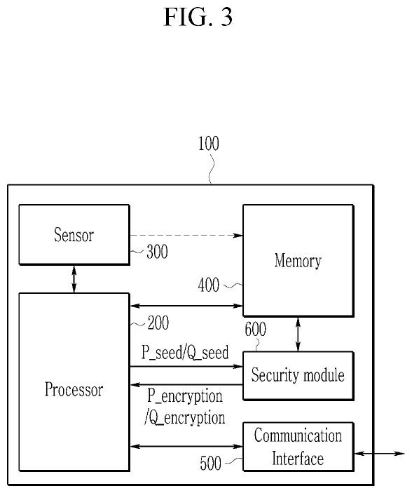

FIG. 3 is a block diagram illustrating hardware configuration of an authentication device, according to an exemplary embodiment.

Referring to FIG. 3, a hardware configuration of the authentication device 100 may vary according to various designs. As illustrated in FIG. 3, the authentication device 100 may include a processor (CPU) 200, at least one sensor 300, at least one memory 400, at least one communication interface 500, and a security module 600.

The sensor 300 is hardware that performs a function of the biometric information detector 110. When the authentication uses the fingerprint as biometric information, the sensor 300 may be a fingerprint sensor.

The memory 400 is hardware for storing various information required for the operation of the processor 200. The memory 400 may store an operating system (OS) for driving the processor 200 and programs for various operations such as the authentication information registering method and the authentication method of the authentication device 100 described in an exemplary embodiment. The memory 400 may store the biometric information detected by the sensor 300 during the key generation time of the processor 200. The memory 400 may perform the function of the storage 190. The memory may be implemented separately according to an exemplary embodiment. That is, the biometric information detected by the sensor 300 and data such as the P prime conversion value and the Q prime conversion value may be stored separately in a storage (not illustrated).

The communication interface 500 is hardware for physical connection with external devices. As described with reference to FIG. 2, the communication interface 500 may include a communication interface for connection with the computing device 2000 and a communication interface for one or more network connections.

The security module 600 is hardware that performs the function of the encryptor 150 which encrypts each of the P seed and Q seed with a plurality of keys to generate the P encryption value and the Q encryption value.

The processor 200 communicates with the sensor 300, the memory 400, the communication interface 500, and the security module 600 and controls them. The processor 200 may perform the functions of the biometric information based seed data generator 130 and the authentication information generator 170 by loading a program (for example, a program implementing a seed data generation algorithm and a key generation algorithm, a program for requesting an authentication information registration, a program for authenticating a specific event, etc.) stored in the memory 400.

When the processor 200 is requested to perform authentication information registration (which may be referred to as certificate issuance or public key generation and private key generation), a program related to an authentication information registration is loaded. The processor 200 controls (enables) the sensor 300 and receives the biometric information (fingerprint information) detected by the sensor 300. The processor 200 generates the P seed and the Q seed containing the biometric information based on the seed data generation algorithm and transfers the P seed and the Q seed to the security module 600. The processor 200 receives the P encryption value and the Q encryption value from the security module 600 and generates the P value and the Q value based on the P encryption value and the Q encryption value. The processor 200 generates the public key and the private key by using the P value and the Q value according to the key generation algorithm. The processor 200 stores the P prime conversion value and the Q prime conversion value in the memory 400. The processor 200 sends the public key to the certificate authority via the communication interface 500. The processor 200 does not store the private key.

Next, when the processor 200 receives a request for authentication (e.g., a digital signature) for the authentication event, the processor 200 loads a program for authentication for the authentication event. The processor 200 generates the P seed and the Q seed based on the biometric information (fingerprint information) detected by the sensor 300 and transfers the P seed and the Q seed to the security module 600. The processor 200 generates the P value and the Q value based on the P encryption value and the Q encryption value, received from the security module 600 and the P prime conversion value and the Q prime conversion value stored in the memory 400. The processor 200 generates the public key and the private key by using the P value and the Q value according to the key generation algorithm. The processor 200 encrypts and electronically signs data (document) with the generated private key and transmits the digitally signed data to the certification authority through the communication interface 500. The processor 200 does not store the private key.

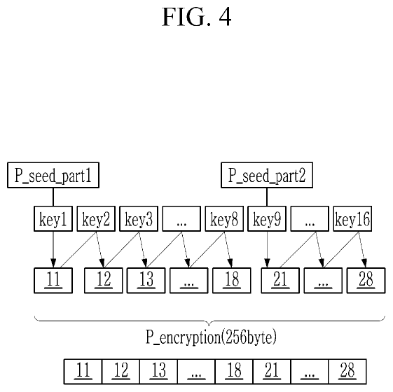

FIG. 4 is a view illustrating a method of generating a P encryption value in an authentication device, according to an exemplary embodiment.

Referring to FIGS. 1 to 4, it is assumed that the authentication device 100 generates a P seed (core_finger_print+sensor_id) that combines sensor identification information and fingerprint information such that the sensor identification information proceeds fingerprint information and a Q seed (sensor_id+core_finger_print) that combines fingerprint information with sensor identification information such that the fingerprint information proceeds the sensor identification information. In addition, it is assumed that the P and Q seeds are 32 bytes, and the P and Q values are assumed to be 256 bytes.

Referring to FIG. 4, the encryptor 150 may store 16 encryption keys from key1 to key16. The encryptor 150 sequentially performs processes of generating a first encrypted data 11 by encrypting a partial data P_seed_part1 (for example, 15 bytes or 16 bytes) of the P seed with the first encryption key, generating a second encrypted data 12 by encrypting the first encryption data 11 with a second first encryption key, and generating a third encryption data 13 by encrypting the second encrypted data 12 with a third encryption key. Through the encryption operations, the encryptor 150 may generate an eighth encryption data 18 (16 bytes) from the first encryption data 11 (16 bytes) using the partial data of the P seed.

Similarly, the encryptor 150 sequentially performs processes of generating a ninth encryption data 21 by encrypting the other partial data P_seed_part2 20 of the P seed with a ninth encryption key, generating a tenth encryption data 22 (not shown) by encrypting the ninth encryption data 21 with a tenth encryption key, and generating an eleventh encryption data 23 (not shown) by encryption of the tenth encryption data 22 with an eleventh encryption key. In this way, the encryptor 150 may generate a 16-th encryption data 28 (16 bytes) from the ninth encryption data 21 (16 bytes) using other partial data of the P seed.

The encryptor 150 may generate a P encryption value of 256 bytes by combining the 16-th encryption data (16 bytes) from the first encryption data (16 bytes).

The authentication information generator 170 may use the P encryption value as a P value when the P encryption value is a prime number, but generates the P encryption value to a prime number according to a predetermined rule to generate the P value which is a prime number. The authentication information generator 170 may generate a prime number closest to the P encryption value as the P value.

In this way, according to an exemplary embodiment, the encryptor 150 and the authentication information generator 170 generates the Q encryption value from the Q seed and generates the Q value which is a prime number from the Q encryption value.

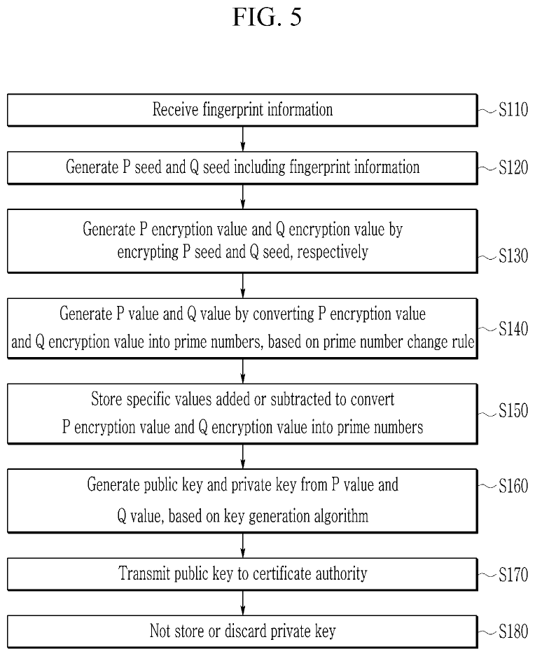

FIG. 5 is a flowchart illustrating a method of registering authentication information, by an authentication device, according to an exemplary embodiment. Herein, the authentication information registration method is a method of generating a public key and a private key, and registering the public key in a certificate authority.

Referring to FIG. 5, the authentication device 100 receives fingerprint information in operation S110.

The authentication device 100 generates a P seed and a Q seed including the fingerprint information in operation S120. At least one of the P seed and the Q seed may further include additional identification information in addition to the fingerprint information. Only one of the P seed and the Q seed may contain fingerprint information.

The authentication device 100 encrypts each of the P seed and Q seed to generate a P encryption value and a Q encryption value having lengths used in a key generation algorithm in operation S130.

The authentication device 100 generates a P value and a Q value obtained by changing the P encryption value and the Q encryption value to a prime number based on a prime number change rule in operation S140. The hydrophobicity of the P and Q values is a requirement of the key generation algorithm.

The authentication device 100 stores a specific value (P prime number conversion value and Q prime number conversion value) added or subtracted to make the P encryption value and the Q encryption value, to be prime numbers in operation S150.

The authentication device 100 generates a public key and a private key from the P value and the Q value, based on the key generation algorithm in operation S160. The key generation algorithm may be an RSA key generation algorithm.

The authentication device 100 transmits the public key to the certificate authority in operation S170. The public key is stored in the certificate authority.

The authentication device 100 does not store (or discard) the private key in operation S180. That is, the authentication device 100 does not store the private key unlike a related art security token and the like. According to an exemplary embodiment, the authentication device 100 discards the private key.

As such, the authentication device 100 may generate a public key and a private key, and transmits the public key to the certificate authority to receive a certificate, according to an exemplary embodiment.

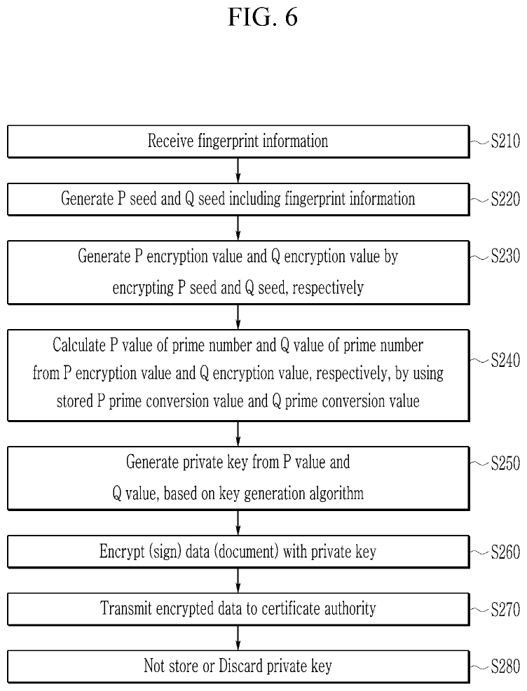

FIG. 6 is a flowchart illustrating an authentication method of authentication for an authentication event, by an authentication device, according to an exemplary embodiment. Here, the authentication for an authentication event is an electronic signature for encrypting (signing) a data (document) related to the authentication event using a private key.

Referring to FIG. 6, the authentication device 100 receives fingerprint information in operation S210.

The authentication device 100 generates a P seed and a Q seed including fingerprint information in operation S220.

The authentication device 100 encrypts each of the P seed and Q seed to generate a P encryption value and a Q encryption value having lengths used in a key generation algorithm in operation S230.

The authentication device 100 calculates a prime number value P and a prime number value Q from the P encryption value and the Q encryption value, respectively, using the stored P prime number conversion value and the Q prime number conversion value in operation S240. The authentication device 100 searches whether the P encryption value and the Q encryption value are stored and uses the stored P encryption value and the Q encryption value. If the P encryption value and the Q encryption value are not stored, the authentication device 100 calculates the P prime number conversion value and the Q prime number conversion value, according to the designated prime number conversion rule.

The authentication device 100 generates a private key from the P value and the Q value, based on the key generation algorithm in operation S250. The key generation algorithm may be an RSA key generation algorithm.

The authentication device 100 encrypts (signs) the data (document) with the private key in operation S260.

The authentication device 100 transmits the encrypted data to the certificate authority in operation S270. The encrypted data is decrypted (authenticated) by the public key stored in the certificate authority.

The authentication device 100 does not store (or deletes or discards) the private key in operation S280.

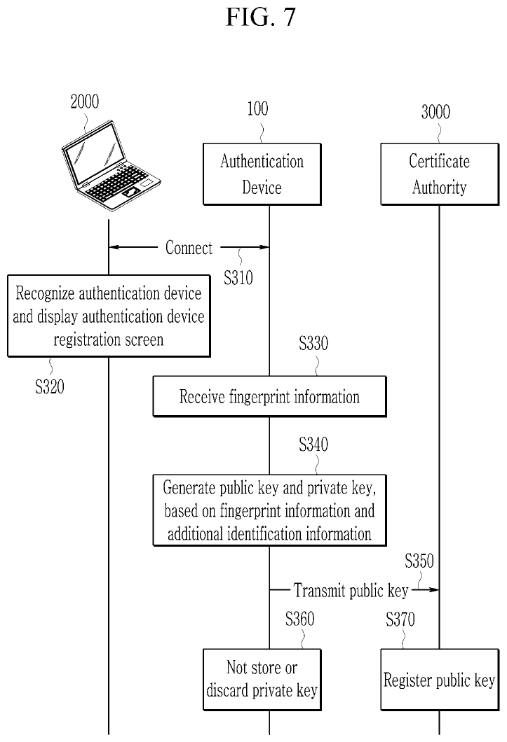

FIG. 7 is a flow diagram illustrating a method of registering authentication information, according to another exemplary embodiment.

Referring to FIG. 7, the authentication device 100 and the computing apparatus 2000 are connected to each other in operation S310.

The computing device 2000 recognizes the authentication device 100 and displays an authentication information registration screen in operation S320. The computing device 2000 drives a program related to the authentication device 100 and supports registration procedure of an authentication information while communicating with the authentication device 100. The computing device 2000 is a device that supports communication between the authentication device 100 and a user and drives a program related to the authentication device 100 to provide a user interface screen. That is, the computing device 2000 may provide the user with guidance for the authentication information registration procedure (e.g., requesting fingerprint input to the authentication device 100) through the display screen.

The authentication device 100 receives the fingerprint information of the user in operation S330. When the authentication device 100 receives the fingerprint information normally, the authentication device 100 may notify of a successful fingerprint input through a notification device (a LED, a speaker, etc.) of the authentication device 100 or display that the fingerprint is input successfully on the authentication device registration screen of the computing device 2000.

The authentication device 100 generates a public key and a private key, based on the fingerprint information and additional identification information in operation S340.

The authentication device 100 transmits the public key to the certificate authority 3000 in operation S350. The public key may be transmitted to the certificate authority 3000 through a communication interface of the authentication device 100. Alternatively, the public key may be transmitted to the computing device 2000 and may be transmitted to the certificate authority 3000 through the communication interface of the computing device 2000.

The authentication device 100 does not store (or deletes or discards) the private key in operation S360.

The certificate authority 3000 registers the public key of the authentication device 100 in operation S370.

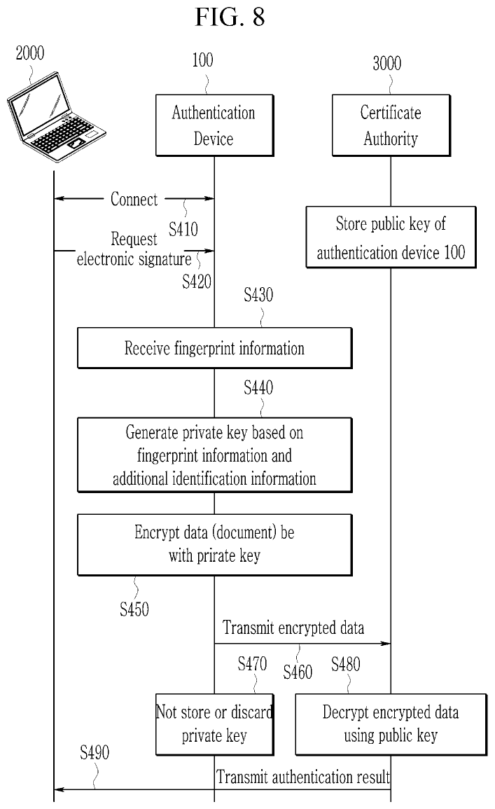

FIG. 8 is a flow diagram illustrating an authentication method, according to another exemplary embodiment.

Referring to FIG. 8, the authentication device 100 and the computing device 2000 are connected to each other in operation S410.

The computing device 2000 requests authentication (e.g., digital signature) for the authentication event, from the authentication device 100 in operation S420. The computing device 2000 may transmit an authentication request message including information related to the authentication event, for example, an authentication required data to the authentication device 100. When the authentication event requiring authentication is generated, the computing device 2000 requests an electronic signature from the authentication device 100. The computing device 2000 performs a digital signature procedure while communicating with the authentication device 100 and provides the user with a guidance for the digital signature procedure (for example, requesting fingerprint input to the authentication device 100) through the display screen. The authentication event includes, for example, financial transactions such as Internet banking, financial settlement for merchandise purchase, web site login, and various events requiring user authentication.

The authentication device 100 receives fingerprint information of the user in operation S430.

The authentication device 100 generates a private key based on the fingerprint information and the additional identification information in operation S440.

The authentication device 100 encrypts the authentication required data (document) with the private key in operation S450. The authentication required data (document) may be, for example, financial transaction information, financial settlement information, login information, and various other event information.

The authentication device 100 transmits the data (digital signature) encrypted with the private key to the certificate authority in operation S460. The encrypted data may be transmitted to the certificate authority 3000 through the communication interface of the authentication device 100. Alternatively, the encrypted data may be transmitted to the computing device 2000 and transmitted to the certificate authority 3000 through the communication interface of the computing device 2000.

The authentication device 100 does not store (or deletes or discards) the private key in operation S470.

The certificate authority 3000 decrypts the encrypted data using the public key of the authentication device 100 in operation S480.

The certificate authority 3000 transmits an authentication result, determined based on the decryption result, to the computing device 2000 in operation S490. When the authentication is performed or normally performed, the computing device 2000 performs procedures such as financial transactions such as Internet banking and financial settlement for purchasing goods or contents.

As described above, according to an exemplary embodiment, since the private key is not stored in the authentication device, there is no possibility that the private key is compromised or leaked to the outside, so that the security level may be higher than other devices storing the private key in the hardware.

Exemplary embodiments described above are not implemented only by the device and the method, but may be implemented through a program for realizing a function corresponding to the configuration of an exemplary embodiment or a recording medium on which the program is recorded.

While exemplary embodiments have been described, it is to be understood that the present disclosure is not limited to the disclosed exemplary embodiments, but, on the contrary, is intended to cover various modifications and equivalent arrangements included within the spirit and scope of the appended claims and their equivalents.

1. A biometric information based authentication device comprising:
a seed data generator which generates seed data comprising biometric information and having a first length;
an encryptor which encrypts the seed data to generate a first encryption value and a second encryption value having a second length, wherein the first encryption value and the second encryption value are different from each other; and
an authentication information generator which generates at least one of a public key and a private key based on each of the first encryption value and the second encryption value which are input,
wherein the private key is discarded after use.

2. The biometric information based authentication device of claim 1, wherein the authentication information generator
generates a first prime value and a second prime value by converting each of the first encrypted value and the second encrypted value to prime numbers, respectively, and
generates the public key and the private key based on a key generation algorithm in which the first prime value and the second prime value are inputs.

3. The biometric information based authentication device of claim 2, wherein the authentication information generator
calculates a first prime conversion value and a second prime conversion value to convert the first encryption value and the second encryption value into the first prime value and the second prime value, respectively, and
stores the first prime conversion value and the second prime conversion value in a storage.

4. The biometric information based authentication device of claim 3, wherein the authentication information generator, in response to receiving the first encryption value and the second encryption value at a time of authenticating an event,
retrieves, from the storage, the first prime conversion value and the second prime conversion value,
calculates the first prime value based on the first encryption value and the first prime conversion value, and
calculates the second prime value based on the second encryption value and the second prime conversion value.

5. The biometric information based authentication device of claim 1, wherein the authentication information generator generates the public key and the private key using an RSA key generation algorithm.

6. The biometric information based authentication device of claim 1, wherein the seed data generator generates the seed data comprising the biometric information and additional identification information, and
wherein the additional identification information comprises at least one of identification information of the authentication device, identification information of a hardware component of the authentication device, and identification information related to a user.

7. A method of registering authentication information by a biometric information based authentication device, the method comprising:
generating seed data comprising biometric information and having a first length;
encrypting the seed data to generate a first encryption value and a second encryption value having a second length, wherein the first encryption value and the second encryption value are different from each other;
generating a first prime value and a second prime value by converting the first encryption value and the second encryption value into prime numbers, respectively;
generating a public key and a private key based on a key generation algorithm in which the first prime value and the second prime value are inputs; and
requesting registration of the authentication information by transmitting the public key to a certificate authority,
wherein the private key is discarded after use.

8. The method of claim 7, wherein the generating the first prime value and the second prime value comprises:
calculating a first prime conversion value and a second prime conversion value to convert the first encryption value and the second encryption value into the first prime value and the second prime value, respectively;
calculating the first prime value based on the first encryption value and the first prime conversion value;
calculating the second prime value based on the second encryption value and the second prime conversion value; and
storing the first prime conversion value and the second prime conversion value.

9. The method of claim 7, wherein the generating the seed data comprises generating the seed data comprising the biometric information and additional identification information, and
wherein the additional identification information comprises at least one of identification information of the authentication device, identification information of a hardware component of the authentication device, and identification information related to a user.

10. The method of claim 9, wherein the biometric information is fingerprint information, and
wherein the generating the seed data comprises generating the seed data by combining the fingerprint information and identification information of a sensor which detects the fingerprint information.

11. An authentication method of a biometric information based authentication device, the method comprising:
receiving an authentication request for a specific event;
receiving biometric information;
generating a private key based on the biometric information;
encrypting data related to the specific event based on the private key; and
transmitting the encrypted data to a certificate authority,
wherein the private key is discarded after the encrypting.

12. The authentication method of claim 11, wherein the generating the private key comprises:
generating seed data comprising the biometric information and having a first length;
encrypting the seed data to generate a first encryption value and a second encryption value having a second length, wherein the first encryption value and the second encryption value are different from each other;
generating a first prime value and a second prime value by converting the first encryption value and the second encryption value into prime numbers, respectively; and
generating the private key based on a key generation algorithm in which the first prime value and the second prime value are inputs.

13. The authentication method of claim 12, wherein the generating the first prime value and the second prime value comprises:
retrieving from storage a first prime conversion value and a second prime conversion value corresponding to the first encryption value and the second encryption value, respectively;
calculating the first prime value based on the first encryption value and the first prime conversion value retrieved; and
calculating the second prime value based on the second encryption value and the second prime conversion value retrieved, wherein the first prime conversion value is used for converting the first encryption value into the first prime value,
wherein the second prime conversion value is used for converting the second encryption value into the second prime value, and
wherein the first prime value and the second prime value are prime numbers.

14. The authentication method of claim 12, wherein the generating the seed data comprises generating the seed data comprising the biometric information and additional identification information, and
wherein the additional identification information comprises at least one of identification information of the authentication device, identification information of a hardware component of the authentication device, and identification information related to a user.

15. The authentication method of claim 11, wherein the specific event comprises at least one of a financial transaction related event, a payment related event, a website login related event, and a user authentication related event.

16. A biometric information based authentication device comprising:
at least one sensor which detects biometric information;
at least one communication interface which communicates with an external device;
a memory which stores a program;
a security module which encrypts input data and outputs encrypted data; and
a processor which interworks with the sensor, the communication interface, the memory, and the security module to execute operations of the program,
wherein the program comprises;
instructions for generating a public key and a private key based on the biometric information received from the sensor, requesting registration of authentication information, and transmitting the generated public key with the requesting, to a certificate authority; and
instructions for generating, in response to receiving an authentication request for a specific event, the private key based on the biometric information received from the sensor, encrypting data related to the specific event based on the generated private key, and transmitting the encrypted data to the certificate authority, and
wherein the generated private key is discarded after use.

17. The authentication device of claim 16, wherein the program comprises a first program executed at a time of requesting the registration of the authentication information, and
wherein the first program comprises instructions for
generating seed data having a first length based on the biometric information received from the sensor,
transmitting the seed data to the security module and receiving from the security module a first encryption value and a second encryption value having a second length, wherein the first encryption value and the second encryption value are different from each other,
generating a first prime value and a second prime value by converting the first encryption value and the second encryption value into prime numbers, respectively,
generating the public key and the private key based on a key generation algorithm in which the first prime value and the second prime value are inputs, and
requesting the registration of the authentication information by transmitting the public key to the certificate authority.

18. The authentication device of claim 17, wherein the instructions for the generating the first prime value and the second prime value comprises
calculating a first prime conversion value and a second prime conversion value to convert the first encryption value and the second encryption value into prime numbers, respectively,
calculating the first prime value based on the first encryption value and the first prime conversion value,
calculating the second prime value based on the second encryption value and the second prime conversion value, and
storing the first prime conversion value and the second prime conversion value.

19. The authentication device of claim 16, wherein the program further comprises a second program executed at a time of the requesting of the authentication of the specific event, and
wherein the second program comprises instructions for
generating seed data having a first length based on the biometric information received from the sensor,
transmitting the seed data to the security module and receiving from the security module a first encryption value and a second encryption value having a second length, wherein the first encryption value and the second encryption value are different from each other,
generating a first prime value and a second prime value by converting the first encryption value and the second encryption value into prime numbers, respectively,
generating the private key based on a key generation algorithm in which the first prime value and the second prime value are inputs, encrypting data related to the specific event based on the private key, and
transmitting the encrypted data to the certificate authority.

20. The authentication device of claim 19, wherein the instructions for the generating the first prime value and the second prime value comprises
retrieving from storage a first prime conversion value and a second prime conversion value corresponding to the first encryption value and the second encryption key, and
calculating, in response to the retrieving the first prime conversion value and the second prime conversion value, the first prime value based on the first encryption value and the first prime conversion value and calculating the second prime value based on the second encryption value and the second prime conversion value.
